(19) United States
(12) Patent Application Publication
(10) Pub. No.: US 2006/0080448 A1
(43) Pub. Date: Apr. 13, 2006

(54) Communication method and terminal between two units

(76) Inventors: Benoit De Boursetty, Paris (FR); Manuel Gruson, Paris (FR); Dimitri Mouton, Paris (FR)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/539,205

(22) PCT Filed: Oct. 27, 2003
(86) PCT No.: PCT/FR03/03181

§ 371 Date: Jun. 17, 2005

(30) Foreign Application Priority Data
Dec. 18, 2002 (FR) 02/16092

(51) Int. Cl. G06F 15/16

(52) U.S. Cl. 709/229

(57) ABSTRACT

Method of communication between a first unit and a second unit via a telecommunications network, the first unit comprising applications belonging respectively to a first family and a second family having a priori a lower degree of confidence than the first family, comprising the step of forcing at least one request originating from an application of the second family, transmitted over the network to the second unit, to include a mark associated with the second family of applications.

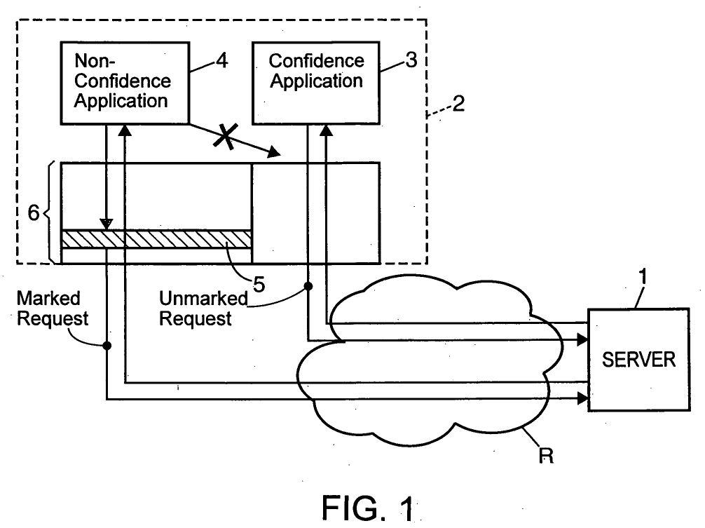

The present invention relates to computer terminals allowing network browser-type activities and offering the users the possibility of installing applications.

Such terminals may in particular be telephones using the wireless application protocol (WAP), office computers, portable computers or personal digital assistants (PDA). They share the common characteristic of being connected to a digital data network which, in many practical cases, is a network operating according to the IP protocol (“internet protocol”), in particular the Internet.

In the case of a “closed” terminal (for example a Minitel), the applications present on the terminal are known and cannot be changed during the lifetime of the terminal.

The openness of a terminal refers to the facility offered to the user to install, and often download, new applications which are intended to be run by the terminal itself. Examples of “open” terminals which integrate this facility are:
application-downloading telephones, for example of the Java MIDP type (“Mobile Information Device Profile”, Sun Microsystems, Inc.);
browsers with scripting functionalities, for example of the WMLScript type (see “WAP WMLScript Language Specification”, version 1.1, WAP Forum, November 2001) or of the ECMAScript type (also referred to as JavaScript, see “ECMAScript Language Specification”, Standard ECMA-262, 3rd edition, December 1999), or browsers which accept applets;
most PDAs, operating under operating systems such as PalmOS, WindowsCE, Symbian etc.;
office or portable computers.

“Semi-open” terminals are open terminals in which certain functionalities are not directly accessible to the applications installed by the user or downloaded. For example, in a terminal whose only “openness” is ECMAScript, downloaded applications cannot access all the functionalities of the network (for example, sending IP packets that do not comply with the formats of the most common transport protocols, that is TCP (“transmission control protocol”) or UDP (“user datagram protocol”). These functionalities may be accessible in an indirect and controlled manner. For example, an ECMAScript function may order the loading of a page via HTTP (“hypertext transfer protocol”)), which uses the network but in a controlled manner.

In “semi-open” terminals, the following coexist:
applications regarded as “confidence” applications, for example because they have been factory-installed by the terminal manufacturer, or because of the guarantee obtained by means such as the electronic signature of the application, etc.;
and other applications which may be installed on the terminal by the user himself, at his own discretion, but which do not access the same rights as the confidence applications.

On the other hand, “fully open” terminals are open terminals in which all functionalities are accessible to the downloaded applications. The concept of openness of a terminal depends largely on the context in which it occurs. For example, different layers of the OSI model (link/network/session/transport/etc.) may have different degrees of openness.

Interest is focused here on the functionalities which can be observed remotely from a server, that is to say network functionalities. In this context, the “semi-open” character of a terminal generally implies that execution rights which can be observed remotely and which are accessible to confidence applications are not accessible to non-confidence applications (for example, the right to transmit requests other than HTTP on an IP network). This allows a server to distinguish, from among the requests received by it, those which originate from confidence applications and whose which originate from other applications. It may in particular distinguish the requests originating from downloaded applications from requests originating from applications present from the start in the terminal.

In open terminals, the possibility that a program may behave in a deceptive manner vis-à-vis the user (Trojan horse) must be taken into account. Thus, nothing can guarantee to a server that a request actually originates from the user and not from a program which has simulated the user's consent in the network. This risk undermines the confidence which the server may have in the data which it receives from a client. The assumption that the requests addressed to the server reflect the actions of the user is not reasonable if a Trojan horse has the facility to send them instead of the user.

A distinction will therefore be made hereinafter between the applications present on the terminal:
confidence applications: the server is ready to make the assumption that these applications are not Trojan horses. For example, the WAP browser of a WAP telephone may constitute a confidence application. Another example may be a Java MIDP application downloaded with signature;
non-confidence applications: the server considers that these applications may be Trojan horses. For example, Java MIDP applications downloaded without signature on a terminal may be non-confidence applications.

The conventional response to the Trojan horse risk is to limit the capabilities of the non-confidence applications.

The limitation of the transmission of frames from semi-open terminals is normally imposed in an extremely strict manner. Only system applications (supplied with the terminal's operating system) are authorized to transmit certain frames.

It therefore becomes impossible for a downloaded application (with or without confidence) to transmit frames to a server, even if that application has means from another source of obtaining the confidence of the server due to the content of the frames that this application transmits (for example: transmitting signed data) or due to characteristics of the application (for example: signature associated with its content).

One object of the present invention is to offer a difference of capability to send requests of a new type between “confidence” applications and “non-confidence” applications that is flexible for the applications and can nevertheless be identified by the receiving server. The concept of confidence may rely on varied criteria (signature, type of interchange, URL from which the application has been downloaded, etc.).

The invention thus proposes a method of communication between a first unit and a second unit via a telecommunications network in which the first unit comprises applications belonging respectively to a first family and a second family having a priori a lower degree of confidence than the first family. According to one aspect of the invention, each request originating from an application of the second family, transmitted over the network to the second unit, is forced to include a mark associated with the second family of applications. According to another aspect of the invention, each request originating from an application of the second family, transmitted over the network to the second unit, is forced to exclude a mark associated with the first family, the said mark being included in at least some of the requests transmitted over the network and originating from applications of the first family. The invention also proposes a communication terminal, comprising means of using such a method as a first unit.

The method allows certain particular (“confidence”) applications running in the first unit to transmit frames for the attention of a second unit, usually a remote server, with the guarantee for this second unit of the reliable origin of these frames. The mandatory inclusion of the mark for the a priori non-confidence applications of the second family (or symmetrically its barring) distinguishes, in transmission, the frames transmitted by these a priori non-confidence applications from those transmitted by confidence applications. This allows the server to sort between acceptable requests, in which it has confidence, and those that it must reject.

The applied mark must be completely “watertight”, that is to say it must not be possible for an a priori non-confidence application to short-circuit the checks made at a certain level (for example: HTTP request functions), by attacking the lowest layers (for example: TCP connection request).

In one embodiment of the method, the mark, included in a request transmitted over the network and originating from an application of the second family is forced to include an indication of the nature and/or origin of the said application of the second family. This indication consists for example in data relating to the certification of the signature of a signed application, or else to the download address of an application downloaded via the network. It may be used by the remote unit to assess whether it may have confidence in the application which a priori could be considered only to be a non-confidence application by the first unit.

Thanks to the method, terminals supporting the downloading of applications may interchange data in full confidence with a server, despite the risks inherent in these download capabilities (“openness” of the terminal). The method thus provides a simple and effective protection against Trojan horses.

Other features and advantages of the present invention will appear in the following description of non-limiting exemplary embodiments, with reference to the appended drawing, in which the single FIGURE is a schematic of a system using the invention.

An attempt is made to allow a remote unit such as a server 1 to obtain in a secure and flexible manner the confidence in requests received over a telecommunications network R from a semi-open terminal 2. This terminal hosts on the one hand confidence applications 3, such as for example a web browser, and on the other hand a priori non-confidence applications 4, particularly applications that the terminal user has downloaded via the network R.

The a priori non-confidence applications 4 are constrained as to the frames or requests that they may transmit over the network R, which, in the schematic, is symbolized by a control layer 5 forming part of the resources 6 for access to the network with which the terminal 2 is equipped.

The control layer 5 verifies that certain properties are fulfilled by the frames transmitted by the a priori non-confidence applications 4. If these properties are fulfilled, the control layer allows the frames to pass. Otherwise, it can either not let them pass to the network R and notify thereof the application 4 that has transmitted them, or modify the frames to make them conform to the requirements of the a priori non-confidence applications. In the latter case, the frame loses its credibility in the eyes of the server 1 which will not be able to exploit it.

The aforementioned constraints relate to the presence or absence of a specific mark in the requests transmitted over the network R from certain applications.

In a first embodiment of the invention, the control layer 5 forces the requests originating from a priori non-confidence applications 4 to include a mark associated with this family of applications. A confidence application 3 gains access to functionalities which allow it to bypass the control layer 5 and transmit unmarked requests. On the other hand, the resources 6 for access to the network do not place these functionalities at the disposal of the a priori non-confidence applications 4.

In an example illustrating this first embodiment, the terminal 2 (for example a mobile telephone) has a Java virtual machine that may correspond to the module 6 in the FIGURE. The virtual machine can be used to run downloaded applications written in the Java programming language produced by Sun Microsystems, Inc. All the Java language instructions are executed by the virtual machine, which calls the system functions after a certain check. The Java applications are clearly in a semi-open environment because there is no unchecked call to the system functions. This terminal 2 is capable of downloading only Java code, no other type of application being able to be installed thereon by the user.

The a priori non-confidence application 4 is then written in Java language.

In this example, the protocols brought into play for the interchanges of the terminal 2 over the network R are the HTTP protocols (RFC 1945 (Request For Comments′), published in May 1996 by the IETF (“Internet Engineering Task Force”)), TCP (RFC 793, IETF, September 1981) and IP (RFC 791, IETF, September 1981).

The service is hosted by an HTTP server 1 which stores the content belonging to the user. It must satisfy itself of the fact that a request (requesting for example the deletion of all the files) effectively comes from the user, and not from a malicious Java program. This service is of course an example, since any other service can use this technique (electronic commerce, document publication, messaging, etc.).

The mark may be included in the “user-agent” header field of the HTTP requests (see section 10.15 of the aforementioned RFC 1945). It consists in a specific string such as “Non-confidence application: VM Java 1.2” which indicates by its presence that the request does not originate from an a priori confidence application. This string may already be present in the request produced by the application 4, in which case the control layer 5 of the virtual machine 6 merely verifies its presence. Otherwise, this layer 5 inserts it so that the request is properly marked.

The watertightness of the mark applied by the virtual machine 6 results from the fact that it is not possible for an a priori non-confidence application 4 to transmit over the network R HTTP requests that do not contain this specific string. In particular, the application 4 cannot have access to the network R by connecting to a protocol layer lower than HTTP, particularly to the TCP sockets. The mark is implemented directly in the virtual machine 6 in which the a priori non-confidence application is obliged to run and which it can in no manner avoid.

The server 1 may thus sort, from among the requests that it receives, those that originate from a priori non-confidence applications 4 and those that originate from confidence applications 3 such as a web browser.

There are applications that are confidence applications for certain sites only. For example, a Java applet is usually considered to be a confidence applet by the site from which it has been downloaded, but not by other sites. The mark will therefore not always be necessary in the requests sent to this download site. In other words, the virtual machine 6 may impose a mark on requests originating from such an applet and transmitted to a site other than that to which it has been downloaded and leave the applet free to include or exclude the mark in the requests that the applet transmits to its source site. Another possibility is to impose the mark on any request transmitted by such an applet, irrespective of its destination.

An alternative or a supplement to the marking of non-confidence requests may be the barring of some of these requests. For example, for non-confidence applications downloaded from a given server, requests direct to different servers may be barred. Requests to the source server would remain possible, with the mark.

In an advantageous embodiment, the mark has to be supplemented by an indication of the nature and/or origin of the a priori non-confidence application 4 from which it has originated.

This a priori non-confidence application 4 may be signed. The requests that originate therefrom will then be marked with a header containing at least one of the following elements likely to establish the remote server's confidence in this application:
the application's signatory's certificate, or a digest of that certificate;
the certificate of the certification chain from where the application's signatory's certificate originated, or a digest of that certificate;
a string specially included in the code of the application for this purpose;
a variable element identifying the application in a dynamic manner.

Such an embodiment of the invention is particularly applicable in the case of a Java application signed by a certificate.

In this case, the virtual machine 6 must verify the signature of the Java application before the transmission of the requests. In practice, this verification takes place before the application 4 is run.

The mark may then consist in the addition of a specific string in the HTTP header, such as for example: “Confidence content — Application signed by <C>” where <C> is the value of the application's signatory's certificate, or a digest of the latter. This header indicates by its presence that the request comes directly from a user, and has been created by a software program of known provenance.

In this manner, if the server 1 places its confidence in the holder of the private keys associated with the certificate <C>, the server is assured that the requests marked in this specific header truly correspond to an effective consent of the user. The marking requirement means that the application cannot claim, to the server, the authority of a signatory other than the real signatory.

In the case of downloaded Java applets, the virtual machine 6 is capable of identifying the download address of the application. It may thus force the request originating from such an applet, an a priori non-confidence request, to include its download address or data relating to that address.

In another embodiment of the invention, the mark syntax is inverted: the control layer 5 forces the requests originating from the a priori non-confidence applications 4 to exclude a mark specific to the confidence applications 3.

To manifest itself as being a confidence application for a server 1, an application 3 then includes the mark in the request that the application 3 sends to the server 1. The control layer 5 ensures that this mark is absent from each request originating from an a priori non-confidence application 4, the non-confidence character being able, as previously, to be judged according to the destination site of the request. If the mark is present in a request originating from an a priori non-confidence application 4, the request is not transmitted as such: the mark is removed by the control layer 5 and the latter may or may not transmit the “demarked” request over the network R and may or may not notify the application 4.

The convention used for the mark syntax must naturally be common to the terminal and the server, and known to both before the transaction.

1. A method of communication between a first unit and a second unit via a telecommunications network, in which the first unit comprises applications belonging respectively to a first family and a second family having a priori a lower degree of confidence than the first family, the method comprising: forcing at least one request originating from an application of the second family, transmitted over the network to the second unit, to include a mark associated with the second family of applications.

2. The method according to claim 1, wherein said mark is included in at least one request transmitted over the network and originating from an application of the second family.

3. The method according to claim 1, wherein the mark, included in a request transmitted over the network and originating from an application of the second family, is forced to include an indication of the nature and/or origin of the said application of the second family.

4. The method according to claim 3, wherein said application of the second family being signed, the mark included in the requests that originated therefrom is forced to include data relating to the certification of the signature.

5. The method according to claim 3, wherein the said application of the second family having been downloaded via the network from a download address, the mark included in the requests that originated therefrom is forced to include data relating to the download address of the application.

6. A method of communication between a first unit and a second unit via a telecommunications network, in which the first unit comprises applications belonging respectively to a first family and to a second family having a priori a lower degree of confidence than the first family, the method comprising: forcing at least one request originating from an application of the second family, transmitted over the network to the second unit, to exclude a mark associated with the first family, the said mark being included in at least some of the requests transmitted over the network and originating from applications of the first family.

7. The method according to claim 6 wherein the second unit examines whether the mark is present in a request received over the network from the first unit, to assess a degree of confidence to be attached to the said request.

8. The method according the claim 7, wherein, when the mark is present the said request, the second unit also examines data included in this mark, to assess a degree of confidence to be attached to said request.

9. The method according to claim 8, wherein said data examined by the second unit comprises data relating to the certification of a signature of the application from which the request originated.

10. The method according to claim 8, wherein said data examined by the second unit comprise data relating to a download address of the application from which the request originated.

11. The method according to claim 6, wherein the requests comprise HTTP requests, and the mark is inserted in the headers of the HTTP requests.

12. The method according to any one of the preceding claim 6, in which the requirement relating to the mark is controlled by a software layer belonging to a virtual machine with which the first unit is provided, the applications of the second family being able to access the network only via the virtual machine and the said software layer.

13. The method according to claim 12, wherein the virtual machine is a Java virtual machine.

14. A communication terminal, comprising means for communicating with a second unit via telecommunications network, the communication terminal further comprising applications belonging respectively to a first family and a second family having a priori a lower degree of confidence than the first family, wherein the means for communicating are adapted to force at least one request originating from an application of the second family, transmitted over the network to the second unit, to include a mark associated with the second family of applications.

15. A communication terminal, comprising means for communicating with a second unit via a telecommunications network, the communication terminal further comprising applications belonging respectively to a first family and a second family having a priori a lower degree of confidence than the first family, wherein the means for communicating are adapted to force at least one request originating from an application of the second family, transmitted over the network to the second unit, to exclude a mark associated with the first family, the said mark being included in at least some of the requests transmitted over the network and originating from applications of the first family.

16. The method according to claim 1, wherein each request originating from an application of the second family, transmitted over the network to the second unit, is forced to include a mark associated with the second family of applications.

17. The method according to claim 6, wherein each request originating from an application of the second family, transmitted over the network to the second unit, is forced to exclude a mark associated with the first family.
